(19) United States
(12) Patent Application Publication
(10) Pub. No.: US 2020/0108765 A1
(43) Pub. Date: Apr. 9, 2020

(54) VARIABLE DISTANCE SPACER FOR VEHICLES, COMPONENT AND SYSTEM

(71) Applicant: Aluminum Industries Investments Pty Ltd, Brighton (AU)

(72) Inventors: Matthew Keen, Brighton (AU); Robin Norman, Brighton (AU)

(21) Appl. No.: 16/706,481

(22) Filed: Dec. 6, 2019

Related U.S. Application Data
(63) Continuation of application No. PCT/AU2019/050035, filed on Jan. 21, 2019.

(30) Foreign Application Priority Data
Jan. 19, 2018 (AU) 2018900171
Jan. 19, 2018 (AU) 2018900179
May 17, 2018 (IB) PCT/IB2018/053476

(51) Int. Cl. B60P 7/15; B62D 24/00; B60R 11/06; F16D 13/75

(52) U.S. Cl. CPC B60P 7/15; B62D 24/00; B60R 2011/0084; F16D 13/75; B60R 11/06

(57) ABSTRACT

A variable distance spacer for use in vehicle assembly which includes two spacer components. Each spacer component includes a base and at least one arm connected to the base. The arm includes a plurality of substantially parallel rails depending therefrom. The rails are evenly offset from each other along the arm, wherein the rails on the arm of one spacer component are configured to slidably engage between two adjacent rails on the arm of the other spacer component along a slide axis, and, when slidably engaged, the spacer components are substantially prevented from moving relative to each other except along the slide axis. The distance between the bases of the two spacer components is changeable by varying which rails are slidably engaged.

### CROSS REFERENCE TO RELATED APPLICATIONS

Continuation of International Application No. PCT/AU2019/050035 filed on Jan. 21, 2019. Priority is claimed from Australian Application No. 2018900171 and 2018900179 both filed on Jan. 19, 2018, and from International Application No. PCT/IB2018/053476 filed on May 17, 2018, all of which applications are incorporated herein by reference in their entirety.

### BACKGROUND

The present invention relates to spacers for spacing apart vehicle components a selected distance from each other. In particular, the present invention relates to a spacer component operable with one object to be spaced apart from another object.

The invention may be useful for spacing apart objects wherein each component operates with a respective spacer component, two or more like spacer components interoperable as a spacer system.

The subject matter and disclosures therein of WO 2018211449 are incorporated by cross-reference.

There are many different body designs and shapes for motor vehicles as well as vehicles towed by motor vehicles such as box trailers, boat trailers and caravans. A vast number of components are used in the construction of such vehicles.

There is also a significant aftermarket business in modifying or converting passenger or commercial vehicles for custom purposes. Vehicles can be modified to facilitate their use for specific roles or purposes such as mining, farming or the transport of people or goods. Vehicles can be modified to better suit the needs of specific trades such as glaziers who may require the replacement of the rear tray of a pickup truck with glass racks or carriers, or more general purposes such as the fitting of ladder or lumber racks

Modifying vehicles is not limited to powered vehicles, for example general purpose boat trailers may need to be customised or modified to fit the body shape of various boats. A wide range of general purpose or custom-built vehicles can be towed by motor vehicles, tractors and used in primary production.

Vehicle safety standards and other regulations can limit the type and nature of the modifications made to vehicles. It is often preferred to use the existing fixture or attachment points on the vehicle chassis as well as those approved for use in service body. Attachment or fitting kits are used to connect the service body to the rest of the vehicle.

In Australia there can be a wide range of service bodies fitted behind the cabin of a pickup truck, coupe utility vehicles (ute), or other light truck. The vehicle may be sold with the driver's cabin and an exposed rear chassis, or it may be fitted with a rear traydeck or tub, which may need to be removed in order to access the chassis to modify the existing structure or fit the necessary service body. It can be expensive to make such modifications as custom service bodies and custom parts and fitting kits may be required for each brand, model, style and build year of the vehicle.

Part of the problem is the need for a business to retain a large inventory of fitting kits just to cover popular makes and models of vehicles. The fitting kit can contain various spacers, brackets and mountings suitable for use with a specific type, brand and year of the vehicle and also a specific service body. Without a fitting kit, the business needs to in a large of inventory of parts and fittings in order to build a custom fitted kit for use with the vehicle. The parts and fittings themselves may need to be modified and customised in order to be suitable for use with a specific vehicle modification project.

The use of parts and fittings can be regulated for vehicle safety purposes. The parts, brackets and components of a fitting kit each may need to be reviewed and certified suitable for use by various engineering and compliance standards. In addition, various Government and road transport authorities may need to inspect and approve of the modifications made the vehicle, including the components used therein.

Presently, spacing of objects is often achieved using fixed height or length spacers. However, such spacers may not be suitable for all applications as the spacing distance required may not match spacing achievable with the fixed height or length spacer. This may be inconvenient as a number of different fixed spacers will be required.

In one example application, spacers of different heights may be required when fitting a deck or other service body to a utility vehicle to provide leveled rails for attaching the deck. Different vehicles have different shaped chassis so that a large number of different spacers would be required.

Some spacers are adjustable and may include a screw and thread means for providing a changeable height spacer for spacing different distances. However, these sorts of adjustable spacers often require a further component or complex design to lock the screw and thread when the adjustment is made to a desired height. Other adjustable length spacers use a pin with multiple apertures, wherein the pin is placed through a selected pair (or two pairs) of apertures which are aligned. The pin and aperture type spacers can be inconvenient as the pin is often a separate and loose component which may be misplaced.

A spacer alone may not be sufficient. The location of the mount points on the chassis is unlikely to match the location of the mounting points on the service body, unless the service body was specifically designed to be used with the vehicle. It can be necessary to include a substructure providing a mounting for fastening to the service body. The substructure can be a cross beam fastened to two nearby spacers, or a frame fastened to and on top of all of the spacers.

### SUMMARY OF THE INVENTION

In one aspect, the present invention provides a vehicle spacer component, operable with another like spacer component as an adjustable spacer, the spacer component including:
one or more arms, each arm including a plurality of substantially parallel rails depending therefrom, the plurality of rails evenly offset from each other along the arm,
wherein, when operated with another like spacer component, at least one rail on each arm of one spacer component is configured to slidably engage between two adjacent rails on each arm of the other spacer component along a slide axis, such that, when slidably engaged, the spacer components are prevented from moving relative to each other except along the slide axis, and
wherein, when operated with another like spacer component, the spacer components form a spacer having two or more selectable spacing lengths.

In another aspect, the present invention provides an adjustable vehicle spacer including two spacer components, each spacer component including:
one or more arms, each arm including a plurality of substantially parallel rails depending therefrom, the plurality of rails evenly offset from each other along the arm,
wherein, when the spacer components are operated with each other, at least one rail on each arm of one spacer component is configured to slidably engage between two adjacent rails on each arm of the other spacer component along a slide axis, such that, when slidably engaged, the spacer components are prevented from moving relative to each other except along the slide axis, and
wherein, when the spacer components are operated with each other, the spacer components form a spacer having two or more selectable spacing lengths.

In yet another aspect, the present invention provides a vehicle spacer system including at least one adjustable spacer and at least two objects to be spaced apart, each adjustable spacer including:
two spacer components, each spacer component including:
   one or more arms, each arm including a plurality of substantially parallel rails depending therefrom, the plurality of rails evenly offset from each other along the arm,
   wherein, when the spacer components are operated with each other, at least one rail on each arm of one spacer component is configured to slidably engage between two adjacent rails on each arm of the other spacer component along a slide axis, such that, when slidably engaged, the spacer components are prevented from moving relative to each other except along the slide axis, and
   wherein, when the spacer components are operated with each other, the spacer components form an adjustable spacer having two or more selectable spacing lengths,
one spacer component of each adjustable spacer configured to be connected to one object and the other spacer component of each adjustable spacer configured to be connected to the object.

In a further aspect, the present invention provides a method for adjustably spacing, the method including:
providing adjustable spacer including two spacer components, each spacer component including:
   one or more arms, each arm including a plurality of substantially parallel rails depending therefrom, the plurality of rails evenly offset from each other along the arm,
   wherein, when the spacer components are operated with each other, at least one rail on each arm of one spacer component is configured to slidably engage between two adjacent rails on each arm of the other spacer component along a slide axis, such that, when slidably engaged, the spacer components are prevented from moving relative to each other except along the slide axis, and
   wherein, when the spacer components are operated with each other, the spacer components form a spacer having two or more selectable spacing lengths.
      the method further including:
slidably engaging the two spacer components to form a spacer having a spacing length selected from the two or more selectable spacing lengths.

In yet a further aspect, the present invention provides a method for spacing two objects apart from each other, the method including:
providing at least one adjustable spacer, each adjustable spacer including two spacer components, each spacer component including:
   one or more arms, each arm including a plurality of substantially parallel rails depending therefrom, the plurality of rails evenly offset from each other along the arm,
   wherein, when the spacer components are operated with each other, at least one rail on each arm of one spacer component is configured to slidably engage between two adjacent rails on each arm of the other spacer component along a slide axis, such that, when slidably engaged, the spacer components are prevented from moving relative to each other except along the slide axis, and
   wherein, when the spacer components are operated with each other, the spacer components form a spacer having two or more selectable spacing lengths,
one spacer component of each adjustable spacer configured to be connected to one object and the other spacer component of each adjustable spacer configured to be connected to the object
   the method further including:
slidably engaging the two spacer components to form a spacer having a spacing length selected from the two or more selectable spacing lengths;
connecting one spacer component to one object; and
connecting the other spacer component to the other object.

A variable distance spacer for use in vehicle assembly which includes two spacer components, each spacer component including a base and at least one arm connected to the base, the arm including a plurality of substantially parallel rails depending therefrom, the plurality of rails evenly offset from each other along the arm; wherein the rails on the arm of one spacer component are configured to slidably engage between two adjacent rails on the arm of the other spacer component along a slide axis; and, when slidably engaged, the spacer components are substantially prevented from moving relative to each other except along the slide axis; and wherein the distance between the bases of the two spacer components can be changed by varying which rails are slidably engaged.

A spacer component capable of being operable with another like spacer component to provide a variable distance spacer as above, the spacer component including a base and at least one arm connected to the base, the arm including a plurality of substantially parallel rails depending therefrom, the plurality of rails evenly offset from each other along the arm; and when operated with another like spacer component, the rails on the arm of the spacer component are configured to slidably engage between two adjacent rails on the arm of the other spacer component along a slide axis; and when slidably engaged, the spacer components are substantially prevented from moving relative to each other except along the slide axis; and wherein the distance between the bases of the two spacer components can be changed by varying which rails are slidably engaged.

### SUMMARY OF SOME OPTIONAL EMBODIMENTS OF THE INVENTION

In embodiments, the or each spacer component includes two or more arms. In various such embodiments, the two or more arms are substantially parallel with each other. In such embodiments, the rails on each arm may depend from a same facing side of each arm.

In other embodiments, the or each spacer component includes a base, wherein the or each arm depends substantially perpendicular from the base.

In further embodiments, each rail has a substantially L-shape cross-section. In such embodiments, each extent of the L-shape cross-section may be of substantially equal width.

In other embodiments, each rail has a “thick-to-thin” L-shape cross-section, wherein a first part of the rail (a first extent of the rail) depending from its respective arm has a substantially rectangular cross-sectional shape, and wherein a second part of the rail (a second extent of the rail) depending from the first part of the rail and substantially orthogonal with respect to the first part of the rail has a substantially trapezoidal cross-sectional shape. In some such embodiments, the trapezoidal cross-sectional shape of the second part of the rail is oriented such that the wider part of the trapezoidal shape depends from the first part of the rail, and the narrower part of the trapezoidal shape projects away from the first part of the rail.

In some other embodiments, the or each arm is substantially planar. In such embodiments, the rails of the arm extend along a side of the arm.

In embodiments, the rails on the or each arm are offset from each other to form a gap between adjacent rails, such that, when the spacer component is operated with another like spacer component, the rails of one spacer component are accommodated snugly between the rails of the other spacer component.

In other embodiments, the base includes a channel adjacent the or each arm and at a side of the or each arm from which the rails depend, the channel shaped, such that, when the spacer component is operated with another like spacer component, the channel snugly accommodates at least a part of a rail from the other spacer component being distal most from the base of the other spacer component.

In various embodiments, the base, on an opposite side from which the or each arm depends, is configured for connecting the spacer component to an object. As such, when connected to the object and when operated with another like spacer component connected to another object, the objects can be spaced apart from each other at one length selected from the two or more selectable spacing lengths. In some embodiments, the configuration for connecting includes a clamp. In other such embodiments, the configuration for connecting includes a threaded joiner operable with apertures through which a part of each threaded joiner can protrude to be threadedly secured.

In some embodiments, the or each arm includes seven (7) rails.

In other embodiments, one spacer component has a first number of rails on the or each arm, and is operable with another spacer component having a second number of rails on each arm different from the first number of rails.

In yet other embodiments, the spacer component, the adjustable spacer, the spacer system and methods for operating same include means for retaining spacer components together when slidably engaged with each other. In one such embodiment, the means for retaining includes one or more grub screws. In one example embodiment, each grub screw may be fastened through a threaded aperture in the arm of one spacer component to frictionally engage with a part of a rail of the other spacer component. In another such embodiment, the spacer components can be adhered together. In an example implementation, adhesive can be applied to rails on the arms of one or both spacer components, the spacer components can be slidably engaged, and the adhesive allowed to set or cure to join the spacer components together.

The spacer can provide various benefits over the known systems. It is expected that a business would only require this spacer for use in fitting kits for many different makes, models and years of vehicles. The parts fitter may stock spacer components of various desired width or desired widths could be cut from a longer section. This reduces the inventory required to be retained by the fitter. It may also reduce the cost of the spacer as it may not be necessary to obtain separate engineering or standards approvals for the spacer component when used on other makes and model and years of vehicles. It may be that only the instructions need to be changed in order to be suitable for use on a different make or model of vehicle.

The two spacer components which together form the spacer be identical or different. Identical spacer components may require the rails to be on the same facing side of each arm. The spacer component may be extruded, such as extruded aluminium, and lengths of an extrusion could be cut as required. This arrangement may provide cost savings with inventory.

Alternatively, the spacer components may be different. The first spacer component may have rails on the opposed inner faces of U shaped member and the second may have rails on the opposed outer faces of a different U shaped member, the two spacers components being appropriately sized to allow the second component to fit within the first. This arrangement may offer other advantages.

In addition one spacer component may have only 2 or 3 rails whereas the other may have 7 or more. This arrangement can provide for the selection of multiple spacings and allow for the use of a simpler die or mould when forming one of the components.

Ordinarily the spacers would be used to space out height. In this context the length or width of a spacer component may be set by the frame or chassis to which it is to be attached. The dimensions of the other spacer component can be comparable to the first spacer component but it is not required to be the same. The other spacer component can also act as a bearer and may be used to connect to a further spacer component, typically across the chassis of the vehicle. Alternatively, the spacer component can protrude outward from first spacer component. The other spacer component could then function as both as a height spacer component and a framing member or bearer for connecting a service body to the chassis.

Further preferred embodiments of the invention may be set out in the claims and are incorporated by cross-reference.

### BRIEF DESCRIPTION OF THE DRAWINGS

At least one embodiment of the invention will be described with reference to the following, non-limiting illustrations representing the at least one embodiment of the present invention, in which:

FIG. 1 is a perspective view of a spacer component, in accordance with an embodiment of the present invention;

FIG. 2 is a reversed and inverted perspective view of the spacer component as shown in FIG. 1, in accordance with an embodiment of the present invention;

FIG. 3 is a side elevation view of the spacer component as shown in FIG. 2, in accordance with an embodiment of the present invention;

FIG. 4 is an opposite end elevation view of the spacer component as shown in FIG. 1, in accordance with an embodiment of the present invention;

FIG. 5 is a side elevation view of the spacer component as shown in FIG. 4, in accordance with an embodiment of the present invention;

FIG. 6 is a perspective view of two spacer components, each connected to an object, the spacer components oriented to slidably engage with each other, in accordance with an embodiment of the present invention;

FIG. 7 is a side elevation view of the two spacer components, each connected to an object, as shown in FIG. 6, in accordance with an embodiment of the present invention;

FIG. 8 is an end elevation view of the two spacer components, each connected to an object, as shown in FIGS. 6 and 7, in accordance with an embodiment of the present invention;

FIG. 9 is a perspective view of two spacer components, each connected to an object, the spacer components slidably engaged with each other to form a spacer having a first selected spacing length, in accordance with an embodiment of the present invention;

FIG. 10 is a side elevation view of the two spacer components, each connected to an object, the spacer components slidably engaged with each other to form a spacer having a first selected spacing length, as shown in FIG. 9, in accordance with an embodiment of the present invention;

FIG. 11 is an end elevation view of the two spacer components, each connected to an object, the spacer components slidably engaged with each other to form a spacer having a first selected spacing length, as shown in FIGS. 9 and 10, in accordance with an embodiment of the present invention;

FIG. 12 is a perspective view of two spacer components, each connected to an object, the spacer components slidably engaged with each other to form a spacer having a second selected spacing length different from the first selected spacing length shown in FIGS. 9, 10 and 11, in accordance with an embodiment of the present invention;

FIG. 13 is a side elevation view of the two spacer components, each connected to an object, the spacer components slidably engaged with each other to form a spacer having a second selected spacing length different from the first selected spacing length shown in FIGS. 9, 10 and 11, as shown in FIG. 12, in accordance with an embodiment of the present invention;

FIG. 14 is an end elevation view of the two spacer components, each connected to an object, the spacer components slidably engaged with each other to form a spacer having a second selected spacing length different from the first selected spacing length shown in FIGS. 9, 10 and 11, as shown in FIGS. 12 and 13, in accordance with an embodiment of the present invention;

FIG. 15 is a perspective view of a spacer component with longer arm sides, base and rails than the spacer components shown in FIGS. 1 to 14, with a discontinuity drawn in long and short dashed lines indicating an indeterminate length of sides, base and rails;

FIG. 16 is an end elevation view of a spacer component with rails and channels formed therebetween having a different cross-sectional shape from those depicted in FIGS. 1 to 15, in accordance with an embodiment of the present invention;

FIG. 17 is a perspective view of the spacer component shown in FIG. 16, in accordance with an embodiment of the present invention;

FIG. 18 is an end elevation view of two spacer components slidably engaged with each other to form a spacer having a first selected spacing length, in accordance with an embodiment of the present invention; and,

FIG. 19 is a perspective view of the spacer component shown in FIG. 18, in accordance with an embodiment of the present invention.

### DETAILED DESCRIPTION OF SOME EMBODIMENTS

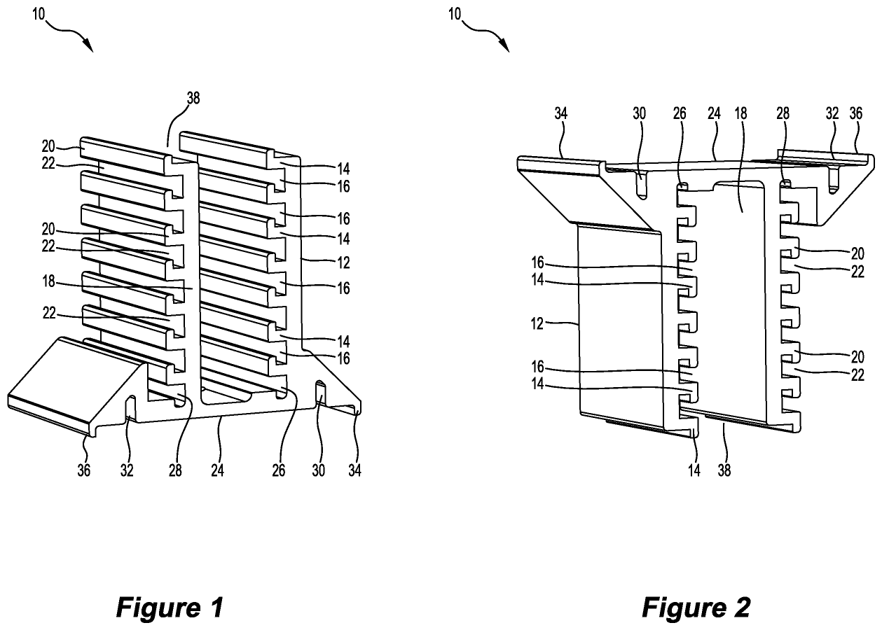

FIG. 1 shows a spacer component 10 including two arms 12 and 18, each arm depending upwardly (as shown in FIG. 1) from a base 24, and the arms being substantially planar parallel with each other. In other embodiments, a spacer component may have a single arm, or may have more than two arms. It will be recognised by the skilled reader that having two or more arms is likely to provide greater rigidity for an adjustable spacer incorporating two such components, while having fewer arms is likely to provide spacer components more easily operated together for slidable engagement.

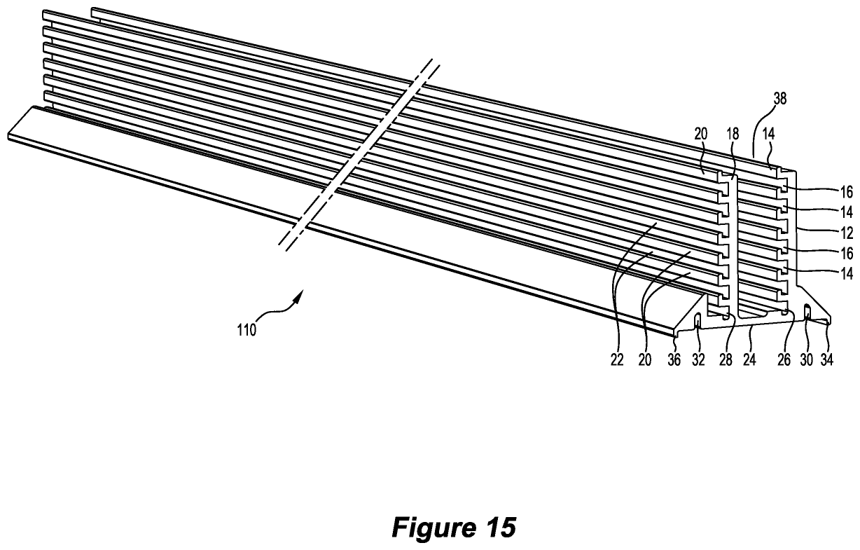

In the embodiment shown in FIG. 1, the arms 12, 18 are planar and have a substantially rectangular shape. However, in other embodiments the arms may have a much wider profile (see, for example, FIG. 15), or could have a narrower profile. It will be recognised by the skilled reader that the wider the arms, the greater the support an adjustable spacer can provide, allowing the spacer to support heavier loads, however, the narrower the arms, the easier to operate to slidably engage two spacer components together.

The arms 12, 18 are separated to form a space 38 therebetween.

Each arm 12, 18 of the spacer component 10 has seven (7) L-shape cross-section rails depending from their respective arm. The rails 14 depending from arm 12 depend inwardly to space 38, and the rails 20 depending from arm 18 depend outwardly from the spacer component. The rails are substantially evenly offset from each other along their respective arm.

Between the lower-most to the upper-most rails 14 (as depicted in FIG. 1) of arm 12 are spaces 16. Similarly, between the lower-most to the upper-most rails 20 (as depicted in FIG. 1) of arm 18 are spaces 22. Each space 16, 22 can be seen to form a L-shape cross-section channel into which rails of another like spacer component can be slid. In embodiments, the rails are shaped and offset from each other so as to provide a space therebetween which tightly or snugly accommodates rails of another like spacer component.

The spacer component 10 includes channel 26 in the base 24, located adjacent arm 12, on the side of the arm from which the rails 14 depend. Similarly, channel 28 is located adjacent arm 18, on the side of the arm from which the rails 20 depend. There is a space formed between the proximal-most rail to the base 24 on each arm 12, 18 and the channels 26 and 28. Each space formed between channel and rail has an L-shape cross-section. These spaces are configured to slidably accommodate rails on a like spacer component, which are distal-most on each respective arm from the base of the like spacer component. It will be appreciated by the skilled reader that the distal-most arms are slid into the respective channel spaces only when the selected spacing length of the spacer components operating together is the shortest spacing length, given the respective bases of each of the spacer components are closest together in such configuration.

The base 24 of the spacer component 10 has a flat area (not shown in FIG. 1) with railings 34 and 36 on each side thereof. The base also includes two channels 30 and 32. The channels 30, 32 provide the base with some flexibility for accommodating an object, and the railings may be configured to assist with clamping a suitably-shaped object.

It will be understood by the skilled reader that there are various means for connecting a spacer component to an object, including adhering, welding, threaded fixers (for example, screws, or nut and bolts), clamping, and any other suitable means.

FIG. 2 shows another view of the spacer component shown in FIG. 1.

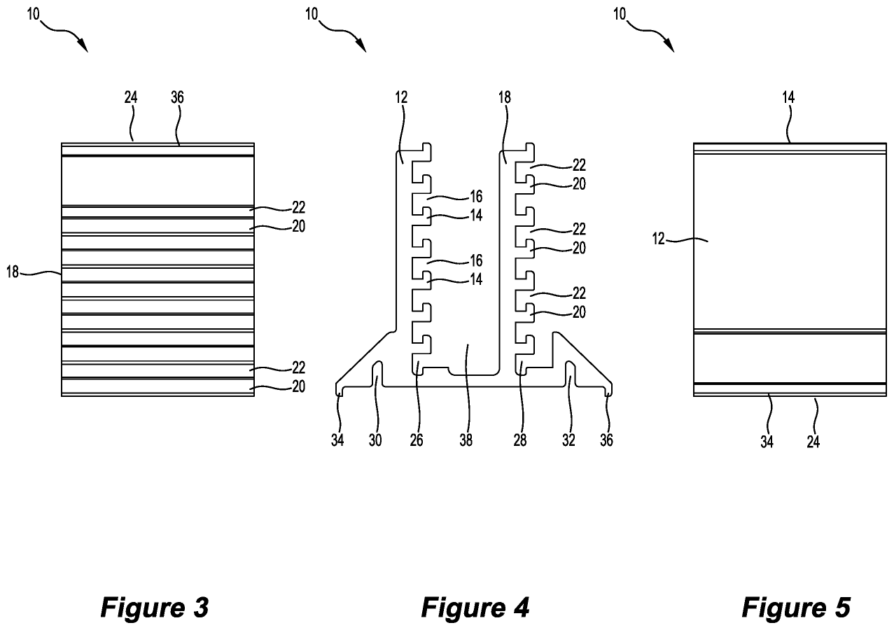

FIG. 3 shows another view of the spacer component shown in FIGS. 1 and 2.

FIG. 4 shows another view of the spacer component shown in FIGS. 1, 2 and 3. In FIG. 4, perhaps it can be more-easily seen that the rails 14, 20 are L-shape cross-section and the spaces formed therebetween, respectively spaces 16 and 22, are L-shape cross-section.

FIG. 5 shows another view of the spacer component shown in FIGS. 1, 2, 3 and 4. The arm 12 shown in FIG. 5 has rails depending inwardly to the space 38, and so the rails 14 cannot be seen in this Figure.

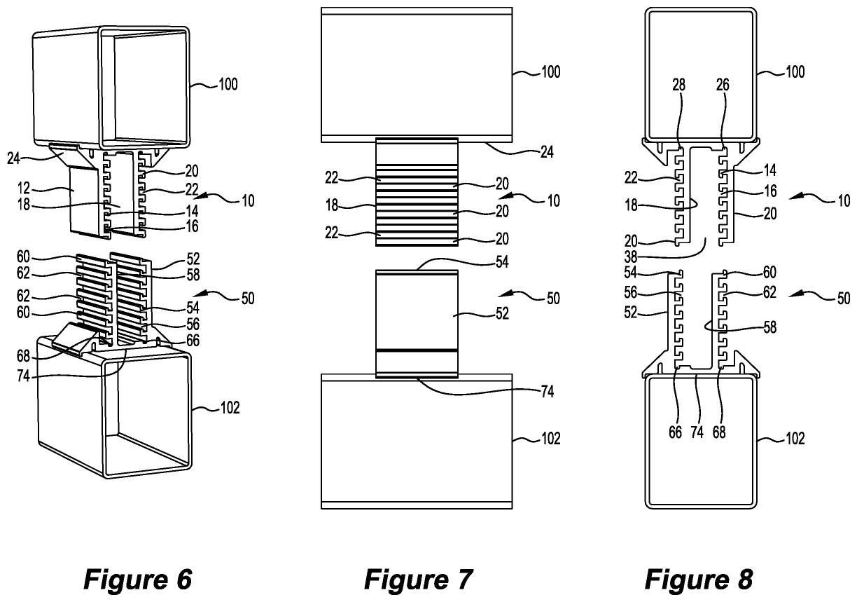

FIG. 6 shows two like spacer components 10 and 50. The first spacer component 10 is connected to object 100 (shown as a section of square cross-section tubing), and the second spacer component 50 is connected to object 102 (also shown as a section of square cross-section tubing). If it is desired to space objects 100 and 102 apart from each other the spacer components 10 and 50 may be used for such purpose.

It will be readily recognised that spacer component 50 (being like spacer component 10) includes two arms 52 and 58. Arm 52 including L-shape cross-section rails 54 depending therefrom and evenly offset from each other along arm 52 so as to form L-shape cross-section spaces 56 therebetween. Similarly, arm 58 includes L-shape cross-section rails 60 depending therefrom and evenly offset from each other along arm 58 so as to form L-shape cross-section spaces 62 therebetween. As will be shown in later Figures, the rails 16 on arm 12 of the first spacer component 10 are accommodated in spaces 62 on arm 58 of the second spacer component 50. Similarly, the rails 20 on arm 18 of the first spacer component 10 are accommodated in spaces 56 on arm 52 of the second spacer component 50. Also, the rails 54 on arm 52 of the second spacer component 50 are accommodated in spaces 22 on arm 18 of the first spacer component 10, and the rails 60 on arm 58 of the second spacer component 50 are accommodated in spaces 16 on arm 12 of the first spacer component 10.

The second spacer component 50 is also depicted with channels 66 and 68, each of which serve a similar (if reciprocal) purpose, as described above, to channels 26 and 28 of the first spacer component 10.

FIG. 7 shows another view of the two like spacer components 10 and 50, each connected, respectively to object 100 and 102, as shown in FIG. 6. FIG. 8 shows yet another view of the two like spacer components 10 and 50, each connected, respectively to object 100 and 102, as shown in FIGS. 6 and 7.

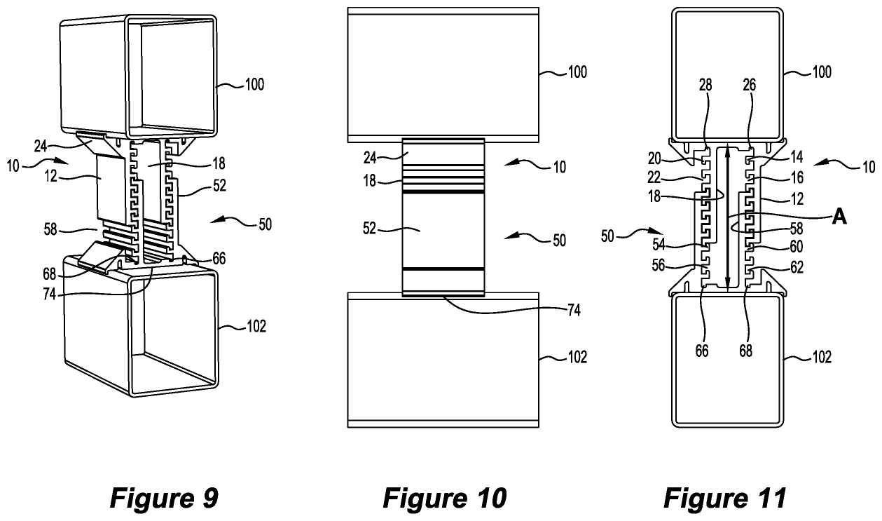

FIG. 9 shows the first spacer component 10 and the second spacer component 50 slidably engaged to form a spacer having a first selected spacing length “A” between objects 100 and 102 (see FIG. 11). The configuration for producing the first selected spacer length has the four (4) rails 14, 20, 54, and 60 of each respective arm 12, 18, 52, and 58 of each of the respective first and second spacer components 10 and 50, which are distal-most from their respective bases 24 and 74, slidably engaging, respectively, with the four (4) spaces 62, 56, 22, and 16 of each respective arm 12, 18, 52, and 58 of each of the respective first and second spacer components 10 and 50, which are distal-most from their respective bases 24 and 74. It will also be noted that the fifth distal-most rail from the base on each arm (third rail away from the respective base) slides along a top part of the distal-most rail of the other spacer component arms.

It will be recognised by the skilled reader that the first selected spacing length “A” demonstrated in FIGS. 9, 10, and 11, is but one possible selectable spacing length. Given seven (7) rails on each arm of each spacer component, along with channels 26, 28, 66, and 68 in respective bases 24 and 74, there are seven (7) possible selectable spacing lengths. However, it will be recognised that, for sufficiently rigid and sufficiently robust formation of a spacer, more than one of the rails on each arm should be slidably engaged with complementary spaces on the other spacer component. In some circumstances, it may be desirable to provide spacer components having wider rails and/or having more than two arms, if it is desired to have the spacer components forming a longer spacer having fewer rails and complementary spaces in slidable engagement.

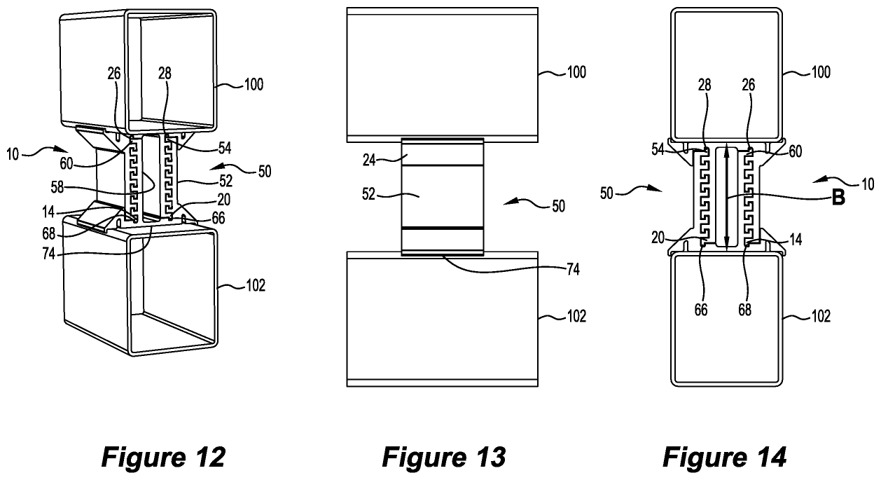

FIGS. 12, 13, and 14 show the spacer components 10 and 50 slidably engaged with each other to form a spacer having a second selected spacing length “B” (see FIG. 14) different from the first selected spacing length “A” shown in FIGS. 9, 10 and 11. Length “B” is shorter than length

In FIGS. 12, 13, and 14, the spacer components 10 and 50 are shown with all rails 14, 20, 54, and 60 engaged with respective complementary spaces 62, 56, 22, and 16. Further, it can be seen that distal-most rails on each arm engage, respectively, in the space formed between channels 26, 28, 66, and 68 and the proximal-most rail on each arm 12, 18, 52, and 58.

FIG. 15 shows another embodiment of a spacer component 110, being longer on arm sides, rails and base than shown in FIGS. 1 to 14. Such a spacer component, when used with another like spacer component, may provide a more robust support for one or more of the objects to be spaced apart. However, such spacer components may be more difficult to slidably engage with other like spacer components.

However, in another example use, the wide spacer component 110 could be used with one or more narrower spacer components as shown in FIGS. 1 to 14.

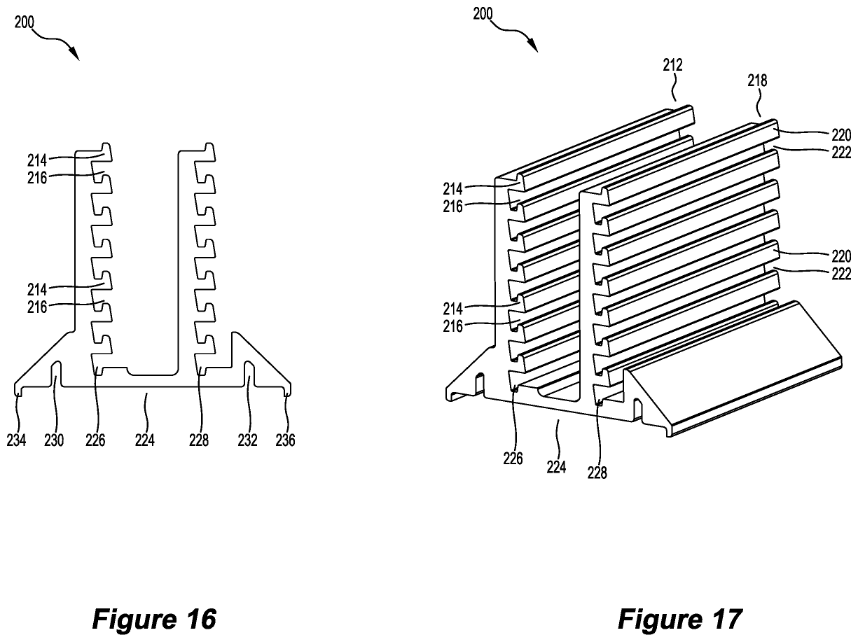

FIG. 16 shows a spacer component 200 including two arms 212 and 218, each arm depending upwardly (as shown in FIG. 16) from a base 224, and the arms being substantially planar parallel with each other. In other embodiments, a spacer component 200 may have a single arm, or may have more than two arms. The arms 212, 218 are planar and have a substantially rectangular shape. The arms 212, 218 are separated to form a space 238 therebetween.

Each arm 212, 218 of the spacer component 200 has seven (7) rails, each rail depending from their respective arm. The rails 214 depending from arm 212 depend inwardly to space 238, and the rails 220 depending from arm 218 depend outwardly from the spacer component 200. The rails are substantially evenly offset from each other along their respective arm. The rails 214, 220 each have a “thick-to-thin” L-shaped cross-section with a first part of each rail depending from its respective arm having a substantially rectangular cross-sectional shape, and a second part of each rail depending from the first part of each rail having a substantially trapezoidal cross-sectional shape.

Between the lower-most to the upper-most rails 214 (as depicted in FIG. 16) of arm 212 are spaces 216. Similarly, between the lower-most to the upper-most rails 220 (as depicted in FIG. 16) of arm 218 are spaces 222. Each space 216, 222 can be seen to form a “thick-to-thin” L-shape cross-section channel into which rails of another like spacer component can be slid. In embodiments, the rails are shaped and offset from each other so as to provide a space therebetween which tightly or snugly accommodates rails of another like spacer component.

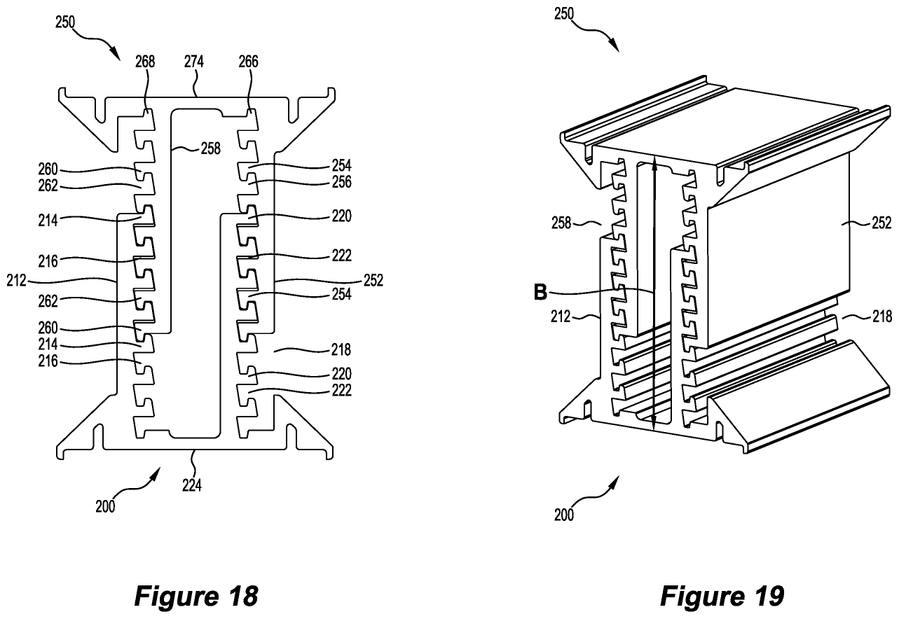

The “thick-to-thin” L-shape cross-section of the rails 214, 220 of spacer component 200, with the second part of each rail having a substantially trapezoidal cross-sectional shape, and the complementary spaces 216, 222 forming “thick-to-thin” L-shape cross-section channels, may provide an advantage with easier sliding when two like spacer components are joined together to form a spacer (as depicted in FIGS. 18 and 19). Further, the “thick-to-thin” L-shape cross-section of the rails 214, 220 and the complementary spaces 216, 222 forming “thick-to-thin” L-shape cross-section channels may provide an advantage in a firmer joining between spacer components forming a spacer. The substantially trapezoidal cross-sectional shape may also provide an advantage in being more resilient against snapping or distorting under a load when compared with other shapes, such as the L-shaped cross-sectioned rails 14, 20 depicted in FIGS. 1 to 15.

The spacer component 200 includes channel 226 in the base 224, located adjacent arm 212, on the side of the arm 212 from which the rails 214 depend. Similarly, channel 228 is located adjacent arm 218, on the side of the arm 218 from which the rails 220 depend. There is a space formed between the proximal-most rail to the base 224 on each arm 212, 218 and the channels 226 and 228. Each space formed between channel and rail has a “thick-to-thin” L-shape cross-section with the second part of each channel having a substantially trapezoidal cross-sectional shape. These spaces are configured to slidably accommodate rails on a like spacer component, which are distal-most on each respective arm from the base of the like spacer component. It will be appreciated by the skilled reader that the distal-most arms are slid into the respective channel spaces only when the selected spacing length of the spacer components operating together is the shortest spacing length, given the respective bases of each of the spacer components are closest together in such configuration.

The base 224 of the spacer component 200 has a flat area with railings 234 and 236 on each side thereof. The base also includes two channels 230 and 232. The channels 230, 232 provide the base with some flexibility for accommodating an object, and the railings may be configured to assist with clamping a suitably-shaped object.

FIG. 17 shows another view of the spacer component 200 shown in FIG. 16.

FIG. 18 shows the first spacer component 200 and the second spacer component 250 slidably engaged to form a spacer having a first selected spacing length “B” (refer to FIG. 19).

Spacer component 250 (being like spacer component 200) includes two arms 252 and 258. Arm 252 including “thick-to-thin” L-shape cross-section rails 254 depending therefrom and evenly offset from each other along arm 252 so as to form “thick-to-thin” L-shape cross-section spaces 256 therebetween. Similarly, arm 258 includes “thick-to-thin” L-shape cross-section rails 260 depending therefrom and evenly offset from each other along arm 258 so as to form “thick-to-thin” L-shape cross-section spaces 262 therebetween. The rails 216 on arm 212 of the first spacer component 200 are accommodated in spaces 262 on arm 258 of the second spacer component 250. Similarly, the rails 220 on arm 218 of the first spacer component 200 are accommodated in spaces 256 on arm 252 of the second spacer component 250. Also, the rails 254 on arm 252 of the second spacer component 250 are accommodated in spaces 222 on arm 218 of the first spacer component 200, and the rails 260 on arm 258 of the second spacer component 250 are accommodated in spaces 216 on arm 212 of the first spacer component 200.

The second spacer component 250 is also depicted with channels 266 and 268, each of which serve a similar (if reciprocal) purpose, as described above, to channels 226 and 228 of the first spacer component 200.

The configuration for producing the first selected spacer length “B” in FIGS. 18 and 19 has the four (4) rails 214, 220, 254, and 260 of each respective arm 212, 218, 252, and 258 of each of the respective first and second spacer components 200 and 250, which are distal-most from their respective bases 224 and 274, slidably engaging, respectively, with the four (4) spaces 262, 256, 222, and 216 of each respective arm 212, 218, 252, and 258 of each of the respective first and second spacer components 200 and 250, which are distal-most from their respective bases 224 and 274. It will also be noted that the fifth distal-most rail from the base on each arm (third rail away from the respective base) slides along a top part of the distal-most rail of the other spacer component arms.

In other embodiments, spacer components may have more than seven (7) rails. In yet other embodiments, spacer components may have less than seven (7) rails. In some example circumstances, spacer components with a different number of rails on respective arms can be used.

In some embodiments, rather than having a base, as depicted in FIGS. 1 to 19, spacer components may comprise only one or more arms with rails, each arm to be separately fixed to an object and spaced apart to complement arms on another object. However, it will be understood by the skilled reader that including a base allows for simpler installation of spacer components, as the distance between arms may be already fixed on the base.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not and should not be taken as an acknowledgement or any form of suggestion that the prior art forms part of the common general knowledge.

What is claimed is:

1. A spacer component capable of being operable with another like spacer component to provide a variable distance spacer for use in vehicle assembly, the spacer component comprising:
a base and at least one arm connected to the base, the arm comprising a plurality of substantially parallel rails depending therefrom, the plurality of rails evenly offset from each other along the arm;
and when operated with the other like spacer component, the rails on the arm of the spacer component are configured to slidably engage between two adjacent rails on the arm of the other like spacer component along a slide axis;
and when slidably engaged, the spacer component and the like spacer component are substantially prevented from moving relative to each other except along the slide axis;
and wherein a distance between the bases of the two spacer components is changeable by varying which rails are slidably engaged.

2. The spacer component according to claim 1, wherein the spacer component comprises two or more arms.

3. The spacer component according to claim 2, wherein the spacer component has 2 arms and a U shaped cross section.

4. The spacer component according to claim 3 wherein each arm depends substantially perpendicular from the base.

5. The spacer component according to claim 4, wherein rails on each arm depend from a same facing side of each arm.

6. The spacer component according to claim 5 wherein each rail has a substantially L-shape cross-section.

7. The spacer component according to claim 6, wherein each extent of the L-shape cross-section is of substantially equal width.

8. The spacer component according to claim 7, wherein the at least one arm is substantially planar.

9. The spacer component according to claim 8, wherein the rails of the at least one arm extend along a side of the at least one arm.

10. The spacer component according to claim 9, wherein the rails on the at least one arm are offset from each other to form a gap between adjacent rails, such that, when the spacer component is operated with another like spacer component, the rails of one spacer component are accommodated snugly between the rails of the other spacer component.

11. The spacer component according to claim 10, wherein the at least one arm comprises seven (7) rails.

12. A variable distance spacer for use in vehicle assembly which comprises one spacer component and another like spacer component, each spacer component comprising:
a base and at least one arm connected to the base, the arm comprising a plurality of substantially parallel rails depending therefrom, the plurality of rails evenly offset from each other along the arm;
and when operated with the other like spacer component, the rails on the arm of the one spacer component are configured to slidably engage between two adjacent rails on the arm of the other like spacer component along a slide axis;
and when slidably engaged, the one spacer component and the other like spacer component are substantially prevented from moving relative to each other except along the slide axis;
and wherein a distance between the bases of the one and the other spacer components is changeable by varying which rails are slidably engaged.

13. The variable distance spacer according to claim 12, wherein the spacer component has a first number of rails on the at least one arm, and is operable with another spacer component having a different number of rails on its at least one arm.

14. The variable distance spacer according to claim 12, wherein one spacer component has inward facing rails and the other spacer component has outward facing rails.

15. The variable distance spacer according to claim 12, wherein the cross sections of the two spacer components are identical.

16. The variable distance spacer according to claim 12, further comprising a retainer for retaining spacer components together when slidably engaged with each other.

17. The variable distance spacer according to claim 16, wherein the retainer comprises one or more grub screws or an adhesive.

18. The variable distance spacer according to claim 12, wherein the base of a spacer component comprises a channel adjacent the at least one arm and the channel shaped at the side from which the rails depend such that, when the spacer component is operated with another like spacer component, the channel snugly accommodates at least a part of a rail from the other spacer component being distal most from the base of the other spacer component.

19. A spacer system comprising:
a first and a second variable distance spacer each of which comprises two spacer components; and
at least two objects to be spaced apart, one spacer component of the first variable distance spacer configured to be connected to a first object of the at least two objects and the other spacer component of the first variable distance spacer configured to be connected to the first object, one spacer component of the second variable distance spacer configured to be connected to a second object of the at least two objects and the other spacer component of the second variable distance spacer is configured to be connected to the second object;
wherein the one spacer component and the other spacer component of each variable distance spacer comprises a base and at least one arm connected to the base, the arm comprising a plurality of substantially parallel rails depending therefrom, the plurality of rails evenly offset from each other along the arm,
and when operated with the other like spacer component, the rails on the arm of the one spacer component are configured to slidably engage between two adjacent rails on the arm of the other like spacer component along a slide axis,
and when slidably engaged, the one spacer component and the like spacer component are substantially prevented from moving relative to each other except along the slide axis,
and wherein the distance between the bases of the spacer components is changeable by varying which rails are slidably engaged.

20. A vehicle fitting kit comprising a variable distance spacer, the variable distance spacer comprising a spacer component and another like spacer component, each spacer component comprising:
a base and at least one arm connected to the base, the arm comprising a plurality of substantially parallel rails depending therefrom, the plurality of rails evenly offset from each other along the arm;
and when operated with the other like spacer component, the rails on the arm of the spacer component are configured to slidably engage between two adjacent rails on the arm of the other like spacer component along a slide axis;
and when slidably engaged, the spacer component and the like spacer component are substantially prevented from moving relative to each other except along the slide axis;
and wherein the distance between the bases of the two spacer components can be changed by varying which rails are slidably engaged.
